(19) United States
(12) Patent Application Publication
(10) Pub. No.: US 2026/0359557 A1
(43) Pub. Date: Nov. 12, 2026

(54) DOCUMENT GENERATION AND EDITING SYSTEM

(71) Applicant: Khaled GAMIET, Iver, Buckinhamshire (GB)

(72) Inventor: Khaled GAMIET, Iver, Buckinhamshire (GB)

(21) Appl. No.: 18/997,266

(22) PCT Filed: Jul. 14, 2023
(86) PCT No.: PCT/GB2023/051863

§ 371 Date: Jan. 21, 2025

(30) Foreign Application Priority Data
Jul. 18, 2022 (GB) 2210510.0

(51) Int. Cl. G06F 40/186; G06F 40/174

(52) U.S. Cl. CPC G06F 40/186; G06F 40/174

(57) ABSTRACT

A computer-implemented method for generating and editing documents comprising receiving and storing a plurality of document templates, each document template comprising a plurality of template elements containing variables and conditions, receiving and storing question responses from a user, generating at least one document by populating the document template variables and conditions with the stored question responses and incorporating template created elements with manually created elements in the final output document.

The present specification relates to document generation and editing system.

Organisations today often need to create, update and review expertly written documentation. These may include contracts, terms and conditions and other legal documents. They may also include policies and procedures such as Health & Safety policies, HR policies, employee handbooks, risk assessments and various other compliance and regulatory documentation, the production of which may be a legal requirement or may be required by the organisations own policy.

These documents are often written by people with some degree of expertise and/or qualifications in the subject, and typically the documents must be customised for each specific case.

One example of such documentation is a patient or service user care plan, which is used to assess and record a Health & Social Care sector service user's care needs and how they are to be cared for. These must be written by a competent person and follow best practice based on the service user's care needs, but they must also be personalised to the individual. In a care home, these documents are typically reviewed and updated on a monthly basis to reflect changes in care.

Maintaining this documentation poses several challenges:
Regulatory requirements means that the care plans contain large amounts of detailed information about the servicer user's care needs.
These documents require time and relevant expertise and competency to write.
They must also be personalised to the individual.
Care needs change so the documentation must be continually updated to reflect these changes.
Often, due to reporting requirements, a single change must be recorded in several different documents.
It can be a challenge to maintain consistency across care plans written by different staff.
The amount and detail of documentation required can take up significant amounts of time which could be better spent with service users.

There are known commercially available solutions which allow users to generate care plans from templates. The care plans may be individually customised within the constraints of the template. However, care plans are updated in line with the service users changing care needs as well as any changes in practices and regulatory requirements, and this requires that previously created care plans must be reviewed and updated.

The object of the present invention is to provide a system that allows such documents to be conveniently generated and updated.

According to the present invention, there is provided a computer-implemented method for generating and editing documents according to claim 1.

The invention will now be described, by way of example, with reference to the drawings, of which

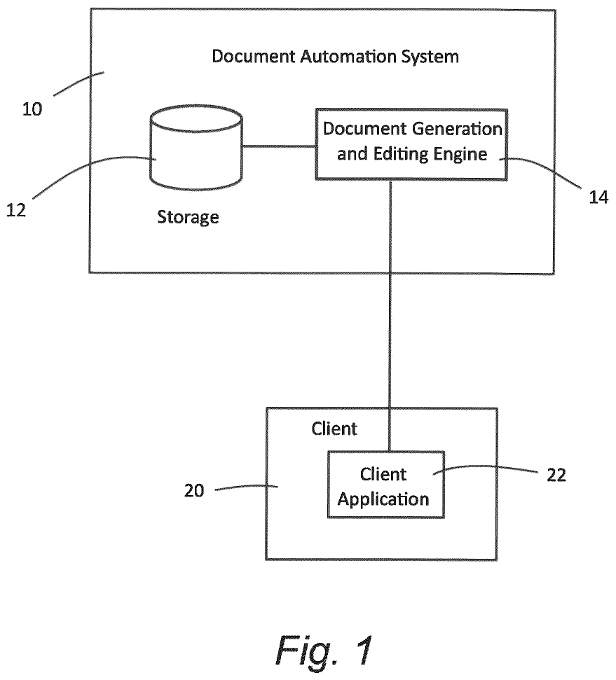

FIG. 1 is a diagrammatic representation of the system;

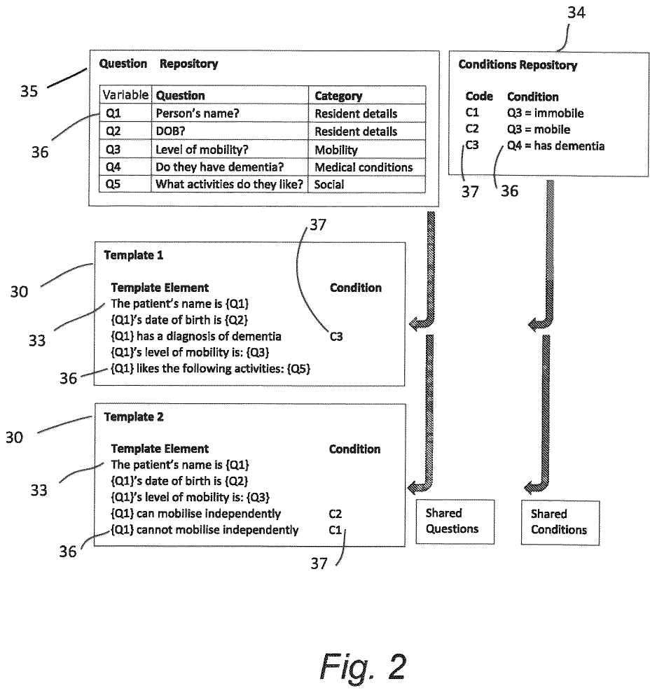

FIG. 2 is a schematic representation of the template and document data; and

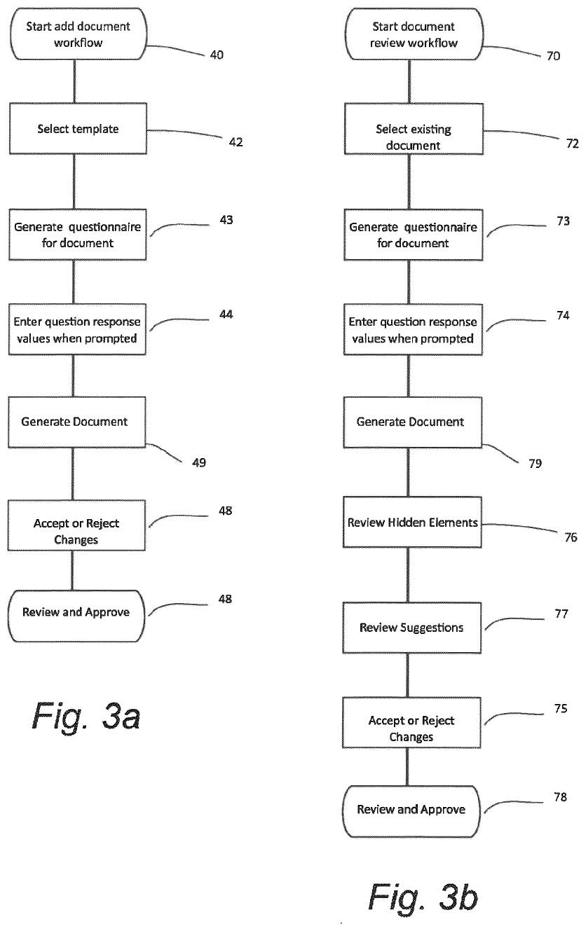

FIG. 3a is a flow diagram of the new document generation process;

FIG. 3b is a flow diagram of the document review process;

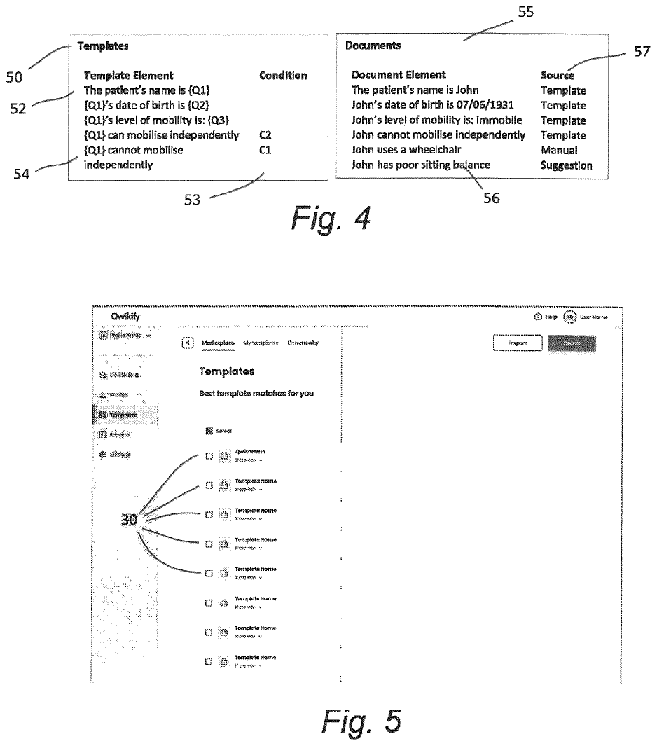

FIGS. 4 to 10 are diagrams illustrating the screen of the client device during the document generation process.

Referring to FIG. 1, client devices 20 are connected to a document automation system 10. The document automation system 10 includes storage 12, and a document generation and editing engine 14. The client devices 20 include an application 22 through which users can access the document automation system 10.

Referring also to FIGS. 2 and 3a, when a user wishes to generate a new document, the user accesses 40 the document automation system 10 through the client application 22 on a client device 20 and begins the add document process. The document automation system organises and stores documents in profiles. A profile is created for each service user to store their data. After selecting a service user profile via a menu, the user starts the add document process. The user is prompted to select 42 the template or templates 30 corresponding to the required new document or documents for that service user, which may also be selected via menu, as shown in FIG. 5.

The client device could be a conventional PC, or a tablet or mobile device, or any other device that allows a user to review material and input data, and of course a combination of these could be used to access the system. Additionally or alternatively to the client device having a client app, the client could be accessed through a web browser, and a document generation and editing engine 14 could be hosted on the document automation system server or another server.”

Each template 30 consists of one or more elements 33. Each element will be composed of text and other graphical material specific to that element and template. Elements may also contain variables 36. Variables allow the text in the template to be customised for each service user profile. When generating documents, the document automation system replaces the variables in the template with data specific to the service user. Variables are stored in a Questions Repository 35. The elements in the template may be made conditional by having conditions 37 attached to them. Conditions contain logic based on the variables which can either be true (and therefore the element is included in a generated document) or false (and therefore the element is not included in the generated document). Such conditions being stored in a Conditions Repository 34.

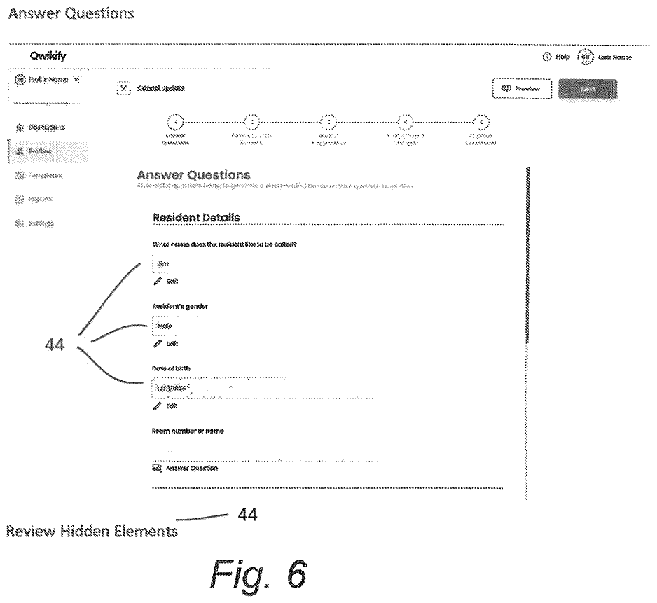

Referring also to FIG. 6, depending on the template selected, the document generation and editing engine 14 uses the question repository 35 to dynamically generate 43 a questionnaire based on the templates linked to the selected documents.

The user is prompted to enter 44 responses to the questions. These responses are later used by the document automation engine 14 to populate the variables 36 in the elements 33 and in the conditions 37. For example, one variable may represent the service user's first name, in which case the user is prompted by the question or instruction ‘What name does the service user like to be called?’. The responses to the relevant questions inputted are stored in the storage 12.

Referring to FIG. 4, for each template 50 a set of template elements 52 are stored in the storage 12, together with variables 54 and conditions value 53. The software also stores a history of all the responses for each question (whether strings, dates, numerical or other values), and uses the most recent response is to dynamically generate the document elements 56 for the required document 55.

When all the necessary responses have been entered by the user, the document generation system the generates 49 the document using the template by replacing the variables 36 with the stored responses in the appropriate place in the document and by evaluating the conditions 37 for each element 33 to determine whether the element should be included in the generated document or not. A draft version of the document has been generated from the template at this stage.

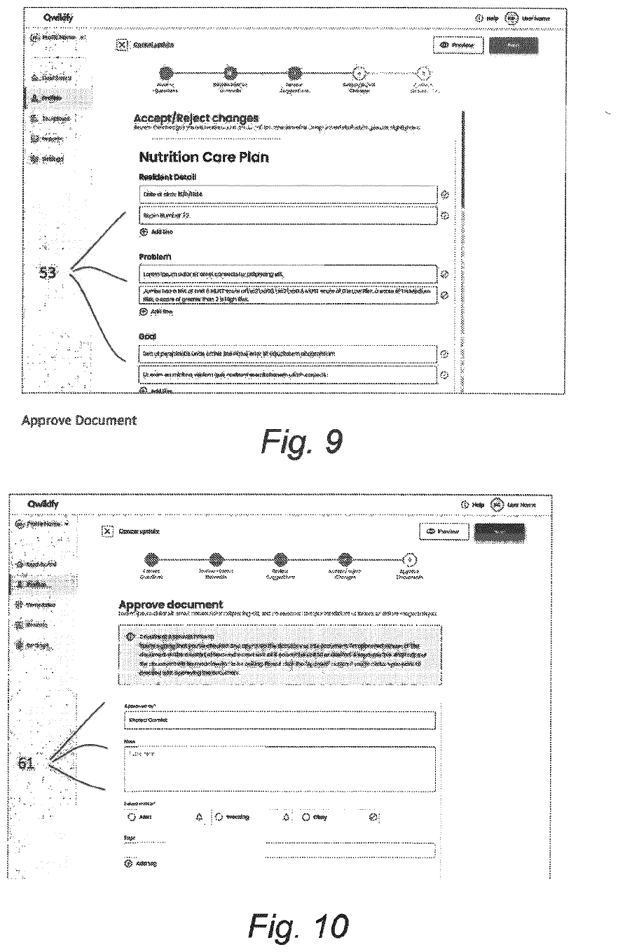

Referring to FIG. 9 the user is presented with the draft document or documents and can make any final manual changes. It is often impractical to prompt and account for all the information a user may need to record in a document. The user can therefore modify the document to enter additional information. The document data is also stored as elements, together with the position in the document. The element also records the element source 57, which may be, for example, ‘Template’, meaning that the element was created from the template 50. However, the user may also add manually generated elements to a document, which are additional or alternative to template elements, and these are stored with the element source value ‘Manual’.

Referring to FIG. 10, when the document has been completed to the user's satisfaction, the document can be approved 48 and locked for editing. An audit trail of approved versions is therefore created.

As previously mentioned documents may be periodically updated. Referring to FIG. 3b, in order to update a document from a template, the user can follow the review document process. The user starts the review document process 70 by selecting 72 an existing document or documents and clicking the review button. The process is similar to the add document process with some additional steps.

The user is presented with a questionnaire 73 which has been dynamically generated based on the selected documents. The questions are pre-populated with the most recent responses. Because the document automation engine uses a shared question and responses repository any previous updates to responses are immediately available to all documents that share the same questions. The user is prompted to enter any updated responses 74.

New templates can be added to the system and presented to users for selection as during the selection step 42 described in relation to FIG. 5; such new templates may include updated version of earlier templates, with these earlier templates being withdrawn or hidden from selection. Again, the questions are pre-populated with the most recent responses added when completing earlier templates, and the user is prompted to enter any updated responses, thus updated templates may be conveniently completed without requiring the re-entering of previously entered data.

The document automation engine uses the question responses to regenerate and update the document 79. However, only the template linked elements are used to update the document. ‘Manual’ element sources are not overwritten when the document is regenerated, but retained in their original or most recent format and so unaffected. This allows documents which have had individual non-template elements added to retain these sections, but update the more templated generated sections; thus, the generation of updated documents is made more efficient without sacrificing important customised sections.

The software may also allow users who do not have sufficient permissions to edit the document to add “Suggestions” 77. Suggestions are the same as manually created elements, but suggestions will not be shown on the final document unless they have been approved by a User with sufficient permissions in a Review Suggestions panel as shown in FIG. 8, which allows a user having sufficient permissions to review 47 and accept or reject suggestions made by other users. Suggestions allow document updates to be “crowd sourced” from a wider pool of users to help improve accuracy and reduce the effort to maintain the documents. Like manually created elements, suggestions will not be affected when the document is regenerated.

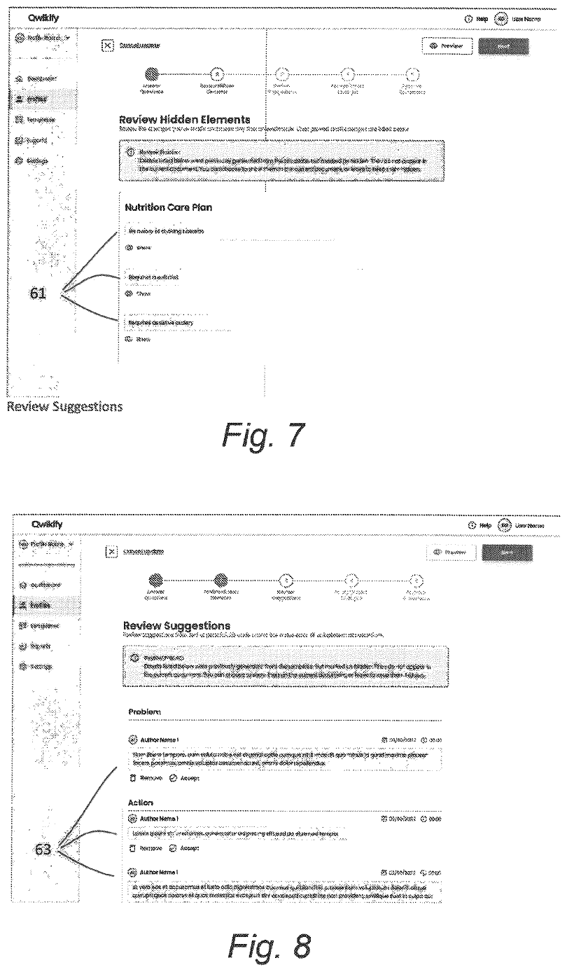

As well as adding or amending elements which will be stored as a manual element source or a suggestion element source, the user can delete template generated elements. If a template generated element is removed or overwritten it is marked “hidden”. Marking it as hidden, rather that deleting it, means that the user has the option to bring the element back in future (which will be described further below). As shown in FIG. 3b and FIG. 7, a user may review 77 any template generated elements which had previously been marked “hidden” as a result of being removed or overwritten by the user, and if appropriate the user may reinstate the hidden element to the document. The user is then prompted to accept/reject changes 75, and review and approve 78, in a similar manner to the add document process described in FIG. 3a.

The system therefore allows multiple documents to be generated from a shared, dynamic generated questionnaire. Users can make manual changes to the generated documents, and then maintain these manual changes after regenerating the documents from the templates. Because documents can be generated/updated simultaneously by changing the responses to questions and by crowd sourcing changes from many users, and these activities are short enough to be set as frequently scheduled tasks documents can be maintained at or near real time.

It will be appreciated that some of the steps may be presented in a different order; for example, the review of hidden elements and the review of suggestions could be straightforwardly reversed. Further, the system may be applied to a wide range of applications, and the advantageous aspects of the system may be provided without utilising every feature presented here; the hidden elements and suggestions may not be required for every application.

In this specification an apparatus/method/product “comprising” certain features is intended to be interpreted as meaning that it includes those features, but that it does not exclude the presence of other features.

Many variations are possible without departing from the scope of the present invention as defined in the appended claims.

1. A computer-implemented method for generating and editing documents comprising receiving and storing a plurality of document templates, each document template comprising a plurality of template elements containing variables and conditions, receiving and storing question responses from a user, generating at least one document by populating the document template variables and conditions with the stored question responses and incorporating template created elements with manually created elements in the final output document.

2. A computer-implemented method according to claim 1 wherein a further document is generated, comprising the additional steps of generating the further document by populating the document template variables and conditions with updated question responses, and incorporating the resulting updated template created elements with manually created elements from the original document which have remained unaltered.

3. A computer-implemented method according to either previous claim wherein template elements may be designated as hidden, such that they do not appear in the generated document.

4. A computer-implemented method according claim 3 wherein template elements designated as hidden can be inspected by the user and the hidden designation removed.

5. A computer-implemented method according to any previous claim wherein template elements may be designated as suggestions, such that another later user is prompted to edit and/or authorise the suggestion before it is included in the generated document.
